(19) United States
(12) Patent Application Publication
(10) Pub. No.: US 2010/0277281 A1
(43) Pub. Date: Nov. 4, 2010

(54) RFID TAG AND METHOD FOR DRIVING THE SAME

(76) Inventor: Hee-Bok Kang, Gyeonggi-do (KR)

Correspondence Address: IP & T Law Firm PLC, 7700 Little River Turnpike, Suite 207, Annandale, VA, 22003, US

(21) Appl. No.: 12/492,192

(22) Filed: Jun. 26, 2009

(30) Foreign Application Priority Data
Apr. 30, 2009 (KR) 10-2009-0038470

(51) Int. Cl. H04Q 5/22

(52) U.S. Cl. 340/10.1

(57) ABSTRACT

A RFID tag includes a voltage multiplication unit configured to generate an internal voltage in response to a RF signal inputted through an antenna, a power level detection unit configured to detect a voltage level of the internal voltage to generate a power level detection signal, a memory block, and a memory auxiliary circuit configured to control the memory block in response to the power level detection signal.

### CROSS-REFERENCE TO RELATED APPLICATIONS

The present application claims priority of Korean Patent Application No. 10-2009-0038470, filed on Apr. 30, 2009, the disclosure of which is incorporated herein by reference in its entirety.

### BACKGROUND OF THE INVENTION

The present invention relates to a radio frequency identification (RFID) system, and more particularly, to a tag of a RFID system.

Generally, a RFID system is constituted with a RFID reader having a reading/decoding function, a RFID tag storing unique tag information, an operating software, and a network. The RFID reader outputs a RF signal through an antenna so as to recognize the RFID tag. The RFID tag receives the RF signal from the RFID reader and transmits a response signal containing tag information to the RFID reader in response to the received RF signal. The RFID reader analyzes the response signal and reads the tag information of the RFID tag.

The RFID tag typically includes a semiconductor transponder chip and an antenna. The RFID tag is typically classified into a passive RFID tag and an active RFID tag according to how an operating voltage is received. The passive RFID tag has no internal power source and operates with energy supplied from a radio wave signal of the RFID reader. The active RFID tag has an embedded battery and operates with an operating voltage supplied from the embedded battery.

Since the RFID tag is a wireless device, a voltage level of an internal voltage used inside of the RFID tag frequently becomes unstable. In this case, each block inside the RFID tag may not operate normally.

### SUMMARY OF THE INVENTION

An embodiment of the present invention is directed to providing a RFID tag which is capable of controlling an internal operation according to a voltage level used in a RFID tag.

In accordance with an aspect of the present invention, there is provided a RFID tag. The RFID tag includes a voltage multiplication unit configured to generate an internal voltage in response to a RF signal inputted through an antenna, a power level detection unit configured to detect a voltage level of the internal voltage to generate a power level detection signal, a memory block, and a memory auxiliary circuit configured to control the memory block in response to the power level detection signal.

In accordance with another aspect of the present invention, there is provided a RFID tag. The RFID tag includes a power level detection unit configured to detect a voltage level of an internal voltage to generate a power level detection signal, a memory block, a gate unit configured to transfer a memory control signal of the memory block when the power level detection signal is activated, and a memory control unit configured to control the memory block by using the memory control signal transferred from the gate unit.

In accordance with another aspect of the present invention, there is provided a method for driving a RFID tag. The method for driving a RFID tag includes generating an internal voltage in response to a RF signal inputted through an antenna, generating a power level detection signal by detecting a voltage level of the internal voltage and controlling a memory block in response to the power level detection signal.

### BRIEF DESCRIPTION OF THE DRAWINGS

FIG. 1 is a block diagram of a RFID tag in accordance with an embodiment of the present invention.

FIG. 2 is a circuit diagram of a power level detection unit of FIG. 1.

FIGS. 3 and 4 are diagrams explaining the operation of the power level detection unit of FIG. 2.

FIG. 5 is a block diagram of a memory auxiliary circuit of FIG. 1.

### DESCRIPTION OF SPECIFIC EMBODIMENTS

Other objects and advantages of the present invention can be understood by the following description, and become apparent with reference to the embodiments of the present invention. In the drawings and detailed description, since the terms, numerals, and symbols used to indicate devices or blocks may be expressed by sub-units, it should be noted that the same terms, numerals, and symbols may not indicate the same devices in a whole circuit.

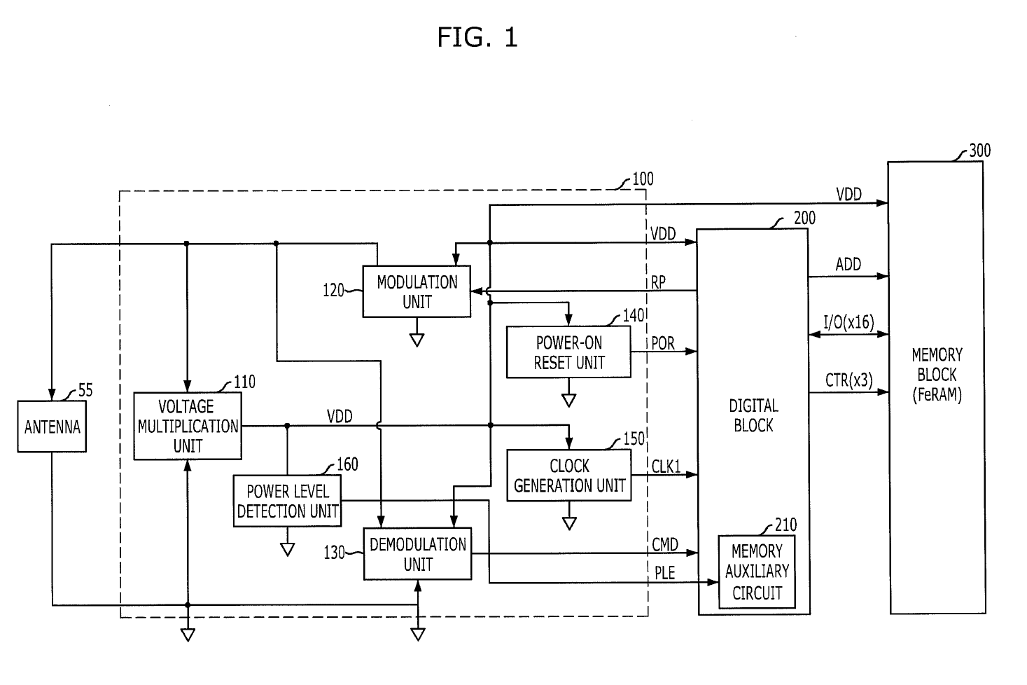

FIG. 1 is a block diagram of a RFID tag in accordance with an embodiment of the present invention.

Referring to FIG. 1, the RFID tag in accordance with the embodiment of the present invention includes an antenna 55, an analog block 100, a digital block 200, and a memory block 300. The antenna 55 receives a RF signal from a RFID reader or writer (not shown), and transfers the received RF signal to the analog block 100. The analog block 100 includes a voltage multiplication unit 110, a modulation unit 220, a demodulation unit 130, a power-on reset unit 140, a clock generation unit 150, and a power level detection unit 160.

The voltage multiplication unit 110 generates an internal voltage VDD used in the RFID tag according to a frequency of a RF signal inputted from the antenna 55. The modulation unit 120 modulates a response signal RP applied from the digital block 200, and transmits the modulated response signal to the antenna 55. The demodulation unit 130 receives the internal voltage VDD from the voltage multiplication unit 110 and the RF signal from the antenna 55, detects a command signal CMD, and outputs the detected command signal CMD to the digital block 200.

The power-on reset unit 140 detects the internal voltage VDD of the voltage multiplication unit 110 and generates a power-on reset signal POR for controlling a reset operation to the digital block 200. The clock generation unit 150 receives the internal voltage VDD of the voltage multiplication unit 110 and generates a clock signal CLK1 for controlling the operation of the digital block 200.

The power level detection unit 160 detects a voltage level of the internal voltage VDD from the voltage multiplication unit 110, and outputs a power detection signal PLE corresponding to the detection result to the digital block 200.

The digital block 200 receives the internal voltage VDD, the power-on reset signal POR, the clock signal CLK1, and the command signal CMD from the analog block 100, and outputs the response signal RP to the modulation unit 120 of the analog block 100. The digital block 200 outputs an address signal ADD, input/output data I/O, and a control signal CTR to the memory block 300. The memory block 300 includes a plurality of nonvolatile ferroelectric memory cells. In particular, the digital block 200 includes a memory auxiliary circuit 210 configured to receive the power detection signal PLE from the power level detection unit 160 and control the memory block 300.

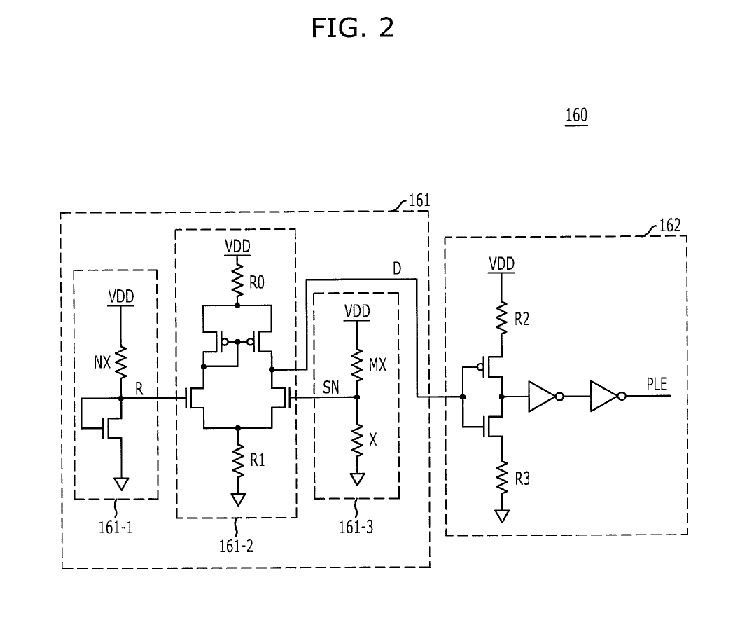

FIG. 2 is a circuit diagram of the power level detection unit of FIG. 1.

Referring to FIG. 2, the power level detection unit 160 includes a voltage detection unit 161 and a detection signal output unit 162. The voltage detection unit 161 includes a reference voltage supplying unit 161-1, a comparison voltage supplying unit 161-3, and a voltage comparing unit 161-2. The reference voltage supplying unit 161-1 supplies a reference voltage R by using a resistor and a MOS transistor. The comparison voltage supplying unit 161-3 supplies a comparison voltage SN by using resistors MX and X. The comparison voltage SN is adjusted by using resistances of the resistors MX and X of the comparison voltage supplying unit 161-3. The voltage comparing unit 161-2 has a differential amplifier structure implemented with PMOS transistors and NMOS transistors. Resistors R0 and R1 of the voltage comparing unit 161-2 serve to reduce current consumption of the voltage comparing unit 161-2. An NMOS transistor of the reference voltage supplying unit 161-1 is turned off when the internal voltage VDD is lower than a threshold voltage, and the threshold voltage of the NMOS transistor becomes the reference voltage R when the internal voltage VDD is higher than the threshold voltage.

The detection signal output unit 162 includes a plurality of inverters connected in series and configured to receive the output signal D of the voltage comparing unit 161-2 to output the power detection signal PLE. The detection signal output unit 162 also serves to amplify the output signal D of the voltage comparing unit 161-2. Resistors of the first inverter included in the detection signal output unit 162 serve to reduce current consumption during the operation of the first inverter.

When the reference voltage R is higher than the comparison voltage SN, the voltage comparing unit 161-2 outputs a high level signal, and the detection signal output unit 162 outputs the power detection signal PLE that is deactivated to a low level. On the other hand, when the reference voltage R is lower than the comparison voltage SN, the voltage comparing unit 161-2 outputs a low level signal, and the detection signal output unit 162 outputs the power detection signal SN that is activated to a high level.

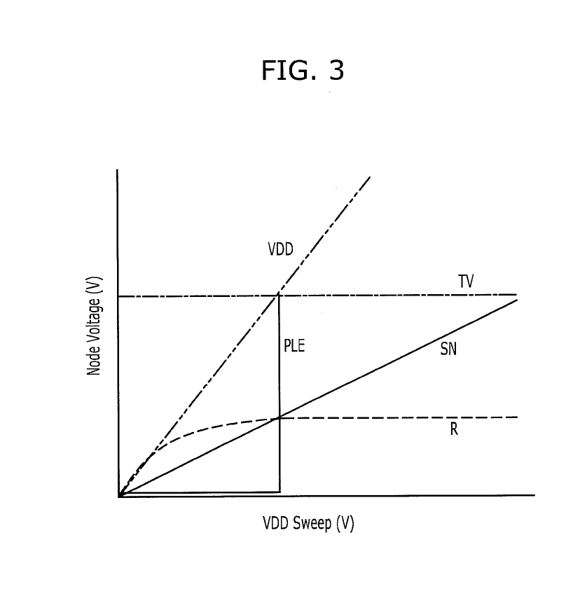

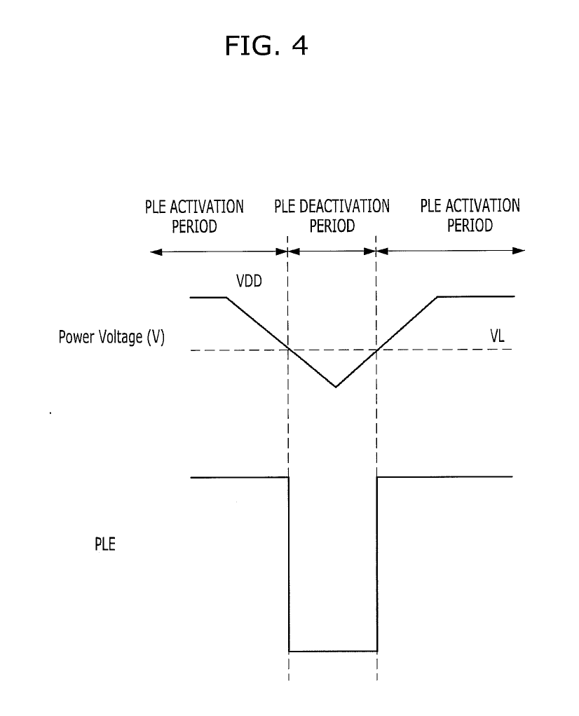

FIGS. 3 and 4 are diagrams explaining the operation of the power level detection unit of FIG. 2.

Referring to FIG. 3, when the internal voltage VDD is higher than a certain level, the power detection signal PLE is activated to a high level. An incremental slope of the comparison voltage SN is determined by a resistance ratio of the resistors MX and X of the comparison voltage supplying unit 161-3. Since the reference voltage R supplied from the reference voltage supplying unit 161-1 uses the threshold voltage of the MOS transistor, it maintains a constant level even though the voltage level of the internal voltage VDD increases.

Referring to FIG. 4, when the internal voltage VDD is higher than the certain level, the power detection signal PLE maintains a high level. When the internal voltage VDD is lower than the certain level, the power detection signal PLE maintains a low level. In FIG. 4, a restriction line VL is a level that detects the voltage level of the internal voltage VDD when it falls down. The restriction line VL may be appropriately determined according to circumstances. The restriction line VL may be determined by adjusting the voltage level of the comparison voltage SN during the internal operation of the power level detection unit 160.

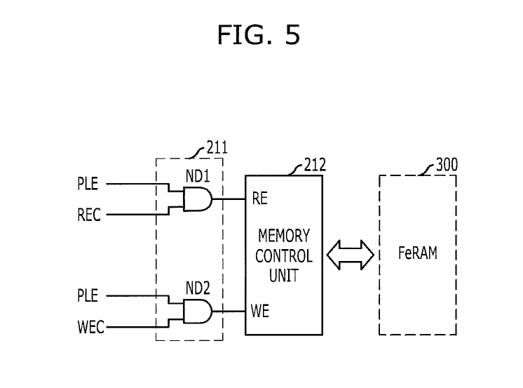

FIG. 5 is a block diagram of the memory auxiliary circuit of FIG. 1.

Referring to FIG. 5, the memory auxiliary circuit 210 includes a gate unit 211 and a memory control unit 211. The gate unit 211 includes two NAND gates ND1 and ND2.

The NAND gate ND1 of the gate unit 211 performs an AND operation on a read control signal REC of the memory block 300 and the power detection signal PLE, and outputs a resulting signal to the memory control unit 212. When the power detection signal PLE is at a low level, the operation of the memory control unit 212 is disabled regardless of the read control signal REC.

The NAND gate ND2 of the gate unit 211 performs an AND operation on a write control signal WEC of the memory block 300 and the power detection signal PLE, and outputs a resulting signal to the memory control unit 212. When the power detection signal PLE is at a low level, the operation of the memory control unit 212 is disabled regardless of the write control signal WEC.

In a period where the power detection signal PLE is at a high level, both the read control signal REC and the write control signal WEC pass through the gate unit 211 and are transferred to the memory control unit 212, and the memory block 300 performs a read or write operation under the control of the memory control unit 212.

Therefore, the power detection signal PLE is activated when the internal voltage is higher than a certain level, and the memory control unit 212 controls the memory block 300 during that period. Since the memory block 300 does not perform the operation other than when the internal voltage VDD of the RFID tag is higher than the certain level, it is possible to reduce data loss that is caused when the voltage level of the internal voltage VDD is low.

In case where the memory block 300 is a nonvolatile memory device, the probability of data loss during the read or write operation will significantly increase if the voltage level of the power supply voltage becomes low. However, in accordance with the embodiment of the present invention, since the memory block 300 of the RFID tag does not operate other than when the internal voltage VDD is higher than a certain level, the probability of data loss is very low. In particular, in the case of the ferroelectric memory device, the use of the RFID tag in accordance with the embodiment of the present invention can prevent the data loss caused by the same cell re-storing conditions in the read operation and the write operation.

In accordance with the embodiment of the present invention, the internal operation of the memory is stopped when the voltage level used within the RFID tag is inappropriate, thereby preventing data loss in the memory. Thus, the operational reliability of the RFID tag is improved.

While the present invention has been described with respect to the specific embodiments, it will be apparent to those skilled in the art that various changes and modifications may be made without departing from the spirit and scope of the invention as defined in the following claims.

What is claimed is:

1. An radio frequency identification (RFID) tag, comprising:
a voltage multiplication unit configured to generate an internal voltage in response to a radio frequency (RF) signal inputted through an antenna;
a power level detection unit configured to detect a voltage level of the internal voltage to generate a power level detection signal;
a memory block; and
a memory auxiliary circuit configured to control the memory block in response to the power level detection signal.

2. The RFID tag of claim 1, wherein the power level detection unit comprises:
a reference voltage supplying unit configured to generate a reference voltage that maintains a constant level;
a comparison voltage supplying unit configured to generate a comparison voltage proportional to the internal voltage; and
a voltage comparing unit configured to compare the reference voltage with the comparison voltage to generate the power level detection signal.

3. The RFID tag of claim 2, wherein the power level detection unit further comprises a detection signal output unit configured to amplify the comparison voltage and output the amplified comparison voltage as the power level detection signal.

4. The RFID tag of claim 2, wherein the reference voltage supplying unit uses a threshold voltage of a MOS transistor in generating the reference voltage.

5. The RFID tag of claim 2, wherein the reference voltage supplying unit comprises:
a resistor having a first terminal connected to the internal voltage; and
a MOS transistor connected between a second terminal of the resistor and a ground terminal and having a gate connected to the second terminal of the resistor.

6. The RFID tag of claim 2, wherein the comparison voltage supplying unit comprises two resistors connected in series, and an incremental slope of the comparison voltage with respect to the internal voltage is determined by a resistance ratio of the two resistors.

7. The RFID tag of claim 2, wherein the voltage comparing unit comprises a differential amplifier.

8. The RFID tag of claim 1, wherein the memory auxiliary circuit comprises:
a gate unit configured to transfer a memory control signal of the memory block when the power level detection signal is activated; and
a memory control unit configured to control the memory block by using the memory control signal transferred from the gate unit.

9. The RFID tag of claim 8, wherein the gate unit comprises:
a first NAND gate configured to receive the power level detection signal and a read control signal of the memory block to output a resulting signal to the memory block; and
a second NAND gate configured to receive the power level detection signal and a write control signal of the memory block to output a resulting signal to the memory block.

10. The RFID tag of claim 9, further comprising:
an analog block configured to generate a power signal and an internal processing signal by using an analog signal provided from an antenna; and
a digital block configured to receive the power signal and a clock signal from the analog block and perform a digital operation, wherein the memory auxiliary circuit is provided in the digital block.

11. The RFID tag of claim 10, wherein the analog block comprises:
a demodulation unit configured to generate an internal signal by using the analog signal provided from the antenna and output the internal signal to the digital block;
a demodulation unit configured to demodulate a response signal provided from the digital block;
a power-on reset unit configured to receive the power signal and provide a power-on reset signal to the digital block; and
a clock generation unit configured to receive the power signal and generate the clock signal to the digital block.

12. A radio frequency identification (RFID) tag, comprising:
a power level detection unit configured to detect a voltage level of an internal voltage to generate a power level detection signal;
a memory block;
a gate unit configured to transfer a memory control signal of the memory block when the power level detection signal is activated; and
a memory control unit configured to control the memory block by using the memory control signal transferred from the gate unit.

13. The RFID tag of claim 12, wherein the power level detection unit comprises:
a reference voltage supplying unit configured to generate a reference voltage that maintains a constant level;
a comparison voltage supplying unit configured to generate a comparison voltage proportional to the internal voltage; and
a voltage comparing unit configured to compare the reference voltage with the comparison voltage to generate the power level detection signal.

14. The RFID tag of claim 13, wherein the power level detection unit further comprises a detection signal output unit configured to amplify the comparison voltage and output the amplified comparison voltage as the power level detection signal.

15. The RFID tag of claim 13, wherein the reference voltage supplying unit uses a threshold voltage of a MOS transistor in generating the reference voltage.

16. The RFID tag of claim 13, wherein the reference voltage supplying unit comprises:
a resistor having a first terminal connected to the internal voltage; and
a MOS transistor connected between a second terminal of the resistor and a ground terminal and having a gate connected to the second terminal of the resistor.

17. The RFID tag of claim 13, wherein the comparison voltage supplying unit comprises two resistors connected in series, and an incremental slope of the comparison voltage with respect to the internal voltage is determined by a resistance ratio of the two resistors.

18. A method for driving a radio frequency identification (RFID) tag, the method comprising:
generating an internal voltage in response to a radio frequency (RF) signal inputted through an antenna;
generating a power level detection signal by detecting a voltage level of the internal voltage; and
controlling a memory block in response to the power level detection signal.

19. The method of claim 18, wherein generating a power level detection signal comprises:
generating a reference voltage that maintains a constant level;
generating a comparison voltage proportional to the internal voltage; and
comparing the reference voltage with the comparison voltage to generate the power level detection signal.
